(19) United States
(12) Patent Application Publication
(10) Pub. No.: US 2024/0119421 A1
(43) Pub. Date: Apr. 11, 2024

(54) NATURAL LANGUAGE PROCESSING AND CLASSIFICATION METHODS FOR A VETERAN'S STATUS SEARCH ENGINE FOR AN ONLINE SEARCH TOOL

(71) Applicants: DAVID PHAM, new york, NY (US); TIFFANY PHAM, new york, NY (US)

(72) Inventors: DAVID PHAM, new york, NY (US); TIFFANY PHAM, new york, NY (US)

(21) Appl. No.: 18/220,823

(22) Filed: Jul. 12, 2023

Related U.S. Application Data
(60) Provisional application No. 63/388,549, filed on Jul. 12, 2022.
(60) Provisional application No. 63/388,550, filed on Jul. 12, 2022.
(60) Provisional application No. 63/391,428, filed on Jul. 22, 2022.
(60) Provisional application No. 63/418,331, filed on Oct. 21, 2022.
(60) Provisional application No. 63/418,356, filed on Oct. 21, 2022.

(51) Int. Cl. G06Q 10/1053; G06F 40/205; G06Q 10/0631

(52) U.S. Cl. CPC G06Q 10/1053; G06F 40/205; G06Q 10/063112

(57) ABSTRACT

In one aspect, a computerized method for dynamically determining a veteran status of a candidate in a set of candidate search results, comprising: generating a searchable online database of diverse candidates; providing the searchable online database of diverse candidates qualified for a specified set of specialized and skilled positions, wherein a job title of candidate is associated with each candidate, and wherein a veteran's status probability is associated with each of the candidates; dynamically determining the veteran's status probability of each candidate in the online database by: parsing the candidate profiles to obtain a set of profile content for each candidate profile in the searchable online database of diverse candidates; matching the set of profile content with a set of veteran-status related keywords; based on a specified number of matches between the set of veteran-status related keywords and the profile content, calculating a probability that each candidate has a veteran status.

### CLAIM OF PRIORITY

This application claims priority to U.S. Provisional Application No. 63/388,549, filed on 12 Jul. 2022 and titled NATURAL LANGUAGE PROCESSING AND CLASSIFICATION METHODS FOR A VETERAN'S STATUS SEARCH ENGINE FOR AN ONLINE SEARCH TOOL. This provisional application is hereby incorporated by reference in its entirety.

This application claims priority to U.S. Provisional Application No. 63/388,550, filed on 12 Jul. 2022 and titled NATURAL LANGUAGE PROCESSING AND CLASSIFICATION METHODS FOR A BOARD-OF-DIRECTOR STATUS SEARCH ENGINE FOR AN ONLINE SEARCH TOOL. This provisional application is hereby incorporated by reference in its entirety.

This application claims priority to U.S. Provisional Application No. 63/391,428, filed on 22 Jul. 2022 and titled NATURAL LANGUAGE PROCESSING AND CLASSIFICATION METHODS FOR A CANDIDATE DISABILITY STATUS SEARCH ENGINE FOR AN ONLINE SEARCH TOOL. This provisional application is hereby incorporated by reference in its entirety.

This application claims priority to U.S. Provisional Application No. 63/418,331, filed on 21 Oct. 2022 and titled WEB INTERFACES FOR MANAGING JOB DIVERSITY NETWORK FEEDS TO A PLURALITY OF WEBSITES. This provisional application is hereby incorporated by reference in its entirety.

This application claims priority to U.S. Provisional Application No. 63/418,356, filed on 21 Oct. 2022 and titled DIVERSIFIED EMPLOYEE SEARCH PROCESSES AND SYSTEMS. This provisional application is hereby incorporated by reference in its entirety.

### BACKGROUND

Despite the ever-growing business case for diversity, roughly eighty-five (85%) of board members and executives continue to be non-diverse leaders. This doesn't mean that companies haven't tried to change. Many have started investing hundreds of millions of dollars on diversity initiatives each year. In light of the desire to diversify company executives, Human Resources (HR) departments are a strategic department within a company as they determine the company's future talent and future consumer, thus affecting the bottom line. Accordingly, HR departments need tool to find diverse candidates. In this way, improvements to HR tools for search for candidates are desired.

### BRIEF SUMMARY OF THE INVENTION

In one aspect, a computerized method for dynamically determining a veteran status of a candidate in a set of candidate search results, comprising: generating a searchable online database of diverse candidates; providing the searchable online database of diverse candidates qualified for a specified set of specialized and skilled positions, wherein a job title of candidate is associated with each candidate, and wherein a veteran's status probability is associated with each of the candidates; dynamically determining the veteran's status probability of each candidate in the online database by: parsing the candidate profiles to obtain a set of profile content for each candidate profile in the searchable online database of diverse candidates; matching the set of profile content with a set of veteran-status related keywords; based on a specified number of matches between the set of veteran-status related keywords and the profile content, calculating a probability that each candidate has a veteran status.

### BRIEF DESCRIPTION OF THE DRAWINGS

FIG. 1 illustrates an online employee search tool and recruitment platform, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example process for dynamically determining an veteran status of a candidate in a set of candidate search results, according to some embodiments.

FIG. 5 illustrates an example screen shot of a set of veteran-status related keywords, according to some embodiments.

The Figures described above are a representative set, and are not an exhaustive with respect to embodying the invention.

### DESCRIPTION

Disclosed are a system, method, and article of manufacture of a natural language processing and classification methods for a veteran's status search engine for an online search tool. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

JSON (JavaScript Object Notation) is an open standard file format, and data interchange format, that uses human-readable text to store and transmit data objects consisting of attribute—value pairs and array data types (and/or any other serializable value).

Natural language processing (NLP) is a subfield of linguistics, computer science, and artificial intelligence concerned with the interactions between computers and human language, in particular how to program computers to process and analyze large amounts of natural language data.

Regular expression (regex) can be a sequence of characters that define a search pattern. Example patterns can be used by string-searching algorithms to implement various operations on strings and/or for input validation.

### Example System

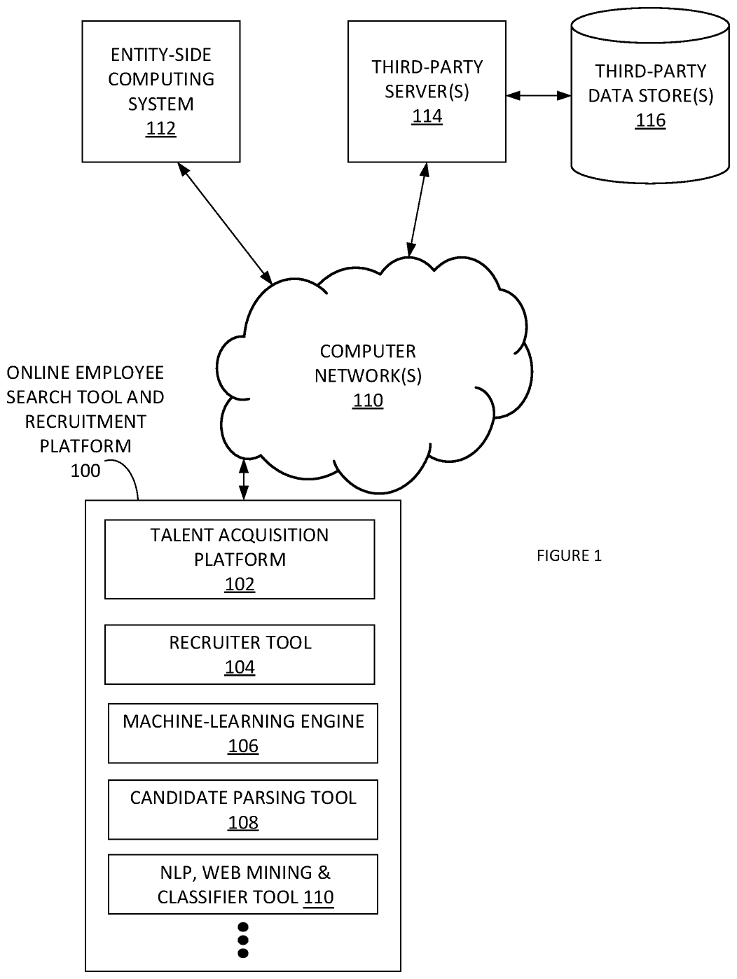

FIG. 1 illustrates an online employee search tool and recruitment platform 100, according to some embodiments. The online employee search tool and recruitment platform can be used to attract and advance diverse talent, from rising-level to the most senior-level leaders worldwide. The online employee search tool and recruitment platform 100 can include a talent acquisition platform 102. Talent acquisition platform 102 can enable an entity (e.g. a company, an educational institution, a religious institution, a non-profit institution, a governmental institution, etc.) to provide a workplace profile. The workplace profile can be used to post and convert specified job opportunities at scale and in a globalized manner. Entities can use talent acquisition platform 102 to build their employer brand by sharing opportunities that attract top diverse talent.

The online employee search tool and recruitment platform 100 can include a Recruiter Tool 104. Recruiter tool 104 can enable executive search services. An entity can perform an executive search to implement a specified type of diversified searches for types of employee based on a set of factors (e.g. experience, demographics, gender, education, current position, work history, other diversity-related metric, ethnicity, veteran status, and the like).

Machine learning engine 106 can utilize machine learning algorithms to recommend and/or optimize various recruiting and candidate parsing functions. For example, candidate parsing tool 108 can use machine learning to optimize candidate parsing. Example machine learning techniques that can be used herein include, inter alio: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

Candidate parsing tool 108 can obtain a dataset of potential position applicants. This database can be obtained from a third-party service. Candidate parsing tool 108 can update the database to specify various candidate attributes. These attributes can include, inter alia: skills, education, ethnic background, racial background, gender, current position, veteran status, etc. Candidate parsing tool 108 can also apply various algorithms to determine potential candidate attributes from other information provided. For example, candidate parsing tool 108 can determine the veteran status of a potential candidate from key words in the candidate's profile (e.g. as derived from the candidate's resume, online LinkedIn profile, etc.). Candidate parsing tool 108 can parse a search of a database of potential position applicants by various requested attributes. In one example, a third-party service can present a large number of potential candidates accessible through an API. In another example, the candidate data can reside in an in-house database.

Candidate parsing tool 108 can implement a search for a CTO. A set of 29,000 results can be obtained. A searching entity can then select a subset of candidates with a specified veteran status option. Candidate parsing tool 108 can filter the returned results to the selected veteran status (e.g. to show only CTOs with a veteran status). Candidate parsing tool 108 can maintain a database of last names and associated veteran status. Candidate parsing tool 108 can maintain a database of institutions that are associated with specified veteran status as well.

NLP, web mining & classifier tool 110 can be used to parse a set of candidate profiles. Candidate profiles can be obtained and generated from digital resumes, business and employment-oriented online service(s) (e.g. LinkedIn®, etc.), and/or the like. NLP, web mining & classifier tool 110 include NLP functionalities. NLP, web mining & classifier tool 110 can include web mining and/or web scrapping functionalities. Web mining is the application of data mining techniques to discover patterns from the World Wide Web. It uses automated methods to extract both structured and unstructured data from web pages, server logs and link structures. NLP, web mining & classifier tool 110 can include classifier functionalities.

Online employee search tool and recruitment platform 100 can include other systems/functionalities not shown. These can include, inter alia: web servers, database managers, email servers, instant message servers, search engines, recommendation engines, online social network engines, geolocation systems, APIs, etc.

Entity-side computing system 112 can be used by entities to access the tools and functionalities of online employee search tool and recruitment platform 100. Entity-side computing system 112 can include web browsers and the like. Entity-side computing system 112 can include any recruiter-side computer systems.

Third-party server(s) 114 can provide various online services. In one example third-party server(s) 114 can be a service(s) that provided access to a set of job candidates via an API. Third-party data store(s) 116 can store data related to third-party server(s) 114.

The systems of FIG. 1 can be communicatively coupled with the various computer network(s) 110 (e.g. the Internet, LANs, WANs, local Wi-Fi, cellular data networks, enterprise network, etc.).

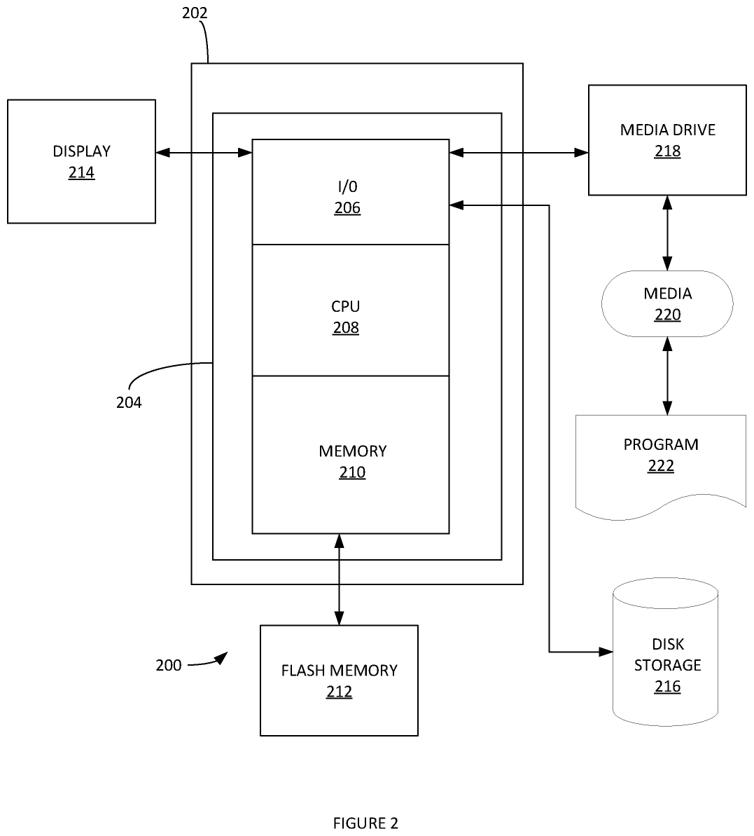

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

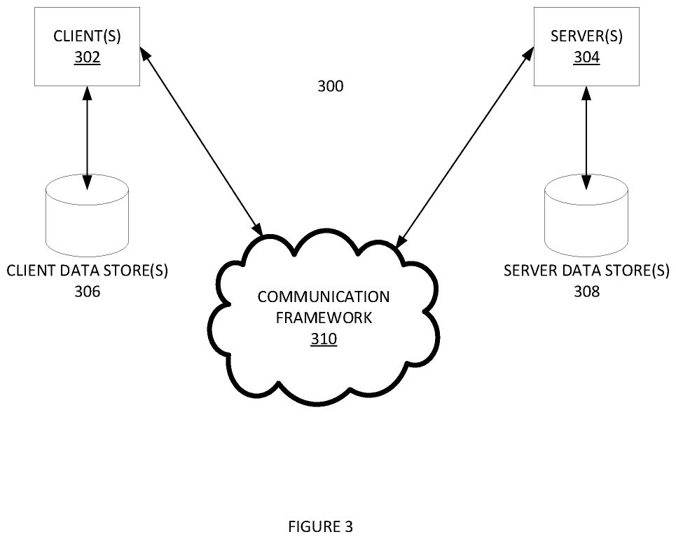

FIG. 3 is a block diagram of a sample-computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data-packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

### Example Processes and Screenshots

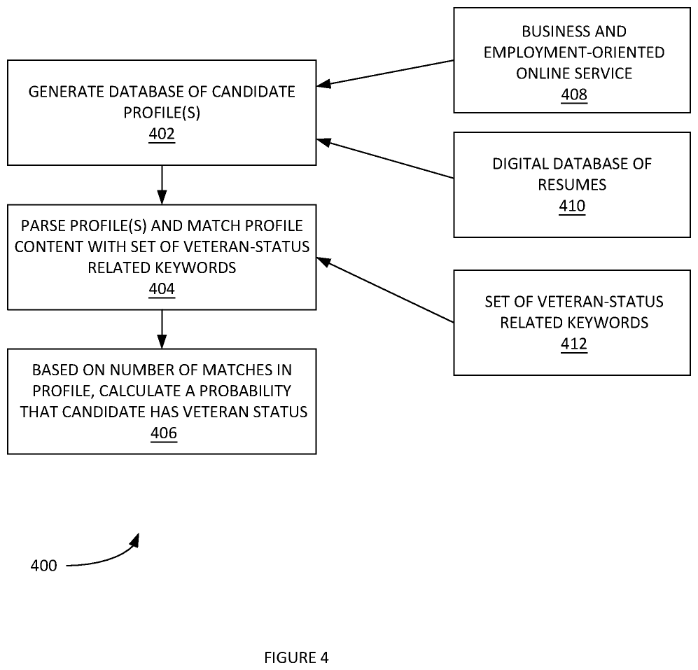

FIG. 4 illustrates an example process 400 for dynamically determining a veteran status of a candidate in a set of candidate search results, according to some embodiments. Process 400 can generate database of candidate profile(s) in step 402. Process 400 can obtain candidate data from various sources. These can include, inter alia: business and employment-oriented online service 408, digital database of resumes 410, etc.

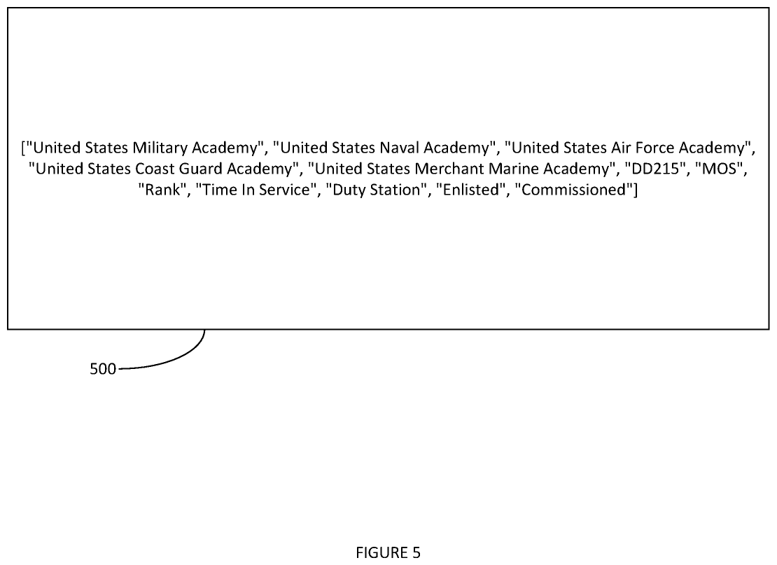

Process 400 can parse profile(s) and match profile content with set of veteran-status related keywords in step 404. Process 400 can use a set of veteran-status related keywords 412. FIG. 5, infra, shows an example set of set of veteran-status related keywords 412 provided by way of example and not of limitation.

Process 400 can, based on number of matches in profile, calculate a probability that candidate has veteran status in step 406. It is noted that a specified number of matches can mean a single match. Process 400 can determine if any of the words within a list of veteran keywords exists within the candidate profile. If yes, process 400 identifies the candidate as a veteran. If no, process 400 does not identify the candidate as a veteran. Process 400 can leverage/utilize various AI systems, like GPT and other large language models, to identify veteran status and/or increase accuracy of veteran status identifications.

FIG. 5 illustrates an example screen shot 500 of a set of veteran-status related keywords, according to some embodiments.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by this United States patent:

1. A computerized method for dynamically determining a veteran status of a candidate in a set of candidate search results, comprising:
generating a searchable online database of diverse candidates;
providing the searchable online database of diverse candidates qualified for a specified set of specialized and skilled positions, wherein a job title of candidate is associated with each candidate, and wherein a veteran's status probability is associated with each of the candidates;
dynamically determining the veteran's status probability of each candidate in the online database by:
parsing the candidate profiles to obtain a set of profile content for each candidate profile in the searchable online database of diverse candidates;
matching the set of profile content with a set of veteran-status related keywords;
based on a specified number of matches between the set of veteran-status related keywords and the profile content, calculating a probability that each candidate has a veteran status.

2. The computerized method of claim 1, wherein the database of candidate profiles is obtained from a business and employment-oriented online service.

3. The computerized method of claim 1, wherein the database of candidate profiles is obtained from a digital database of resumes.

4. The computerized method of claim 1, wherein the set of veteran-status related keywords comprises: “United States Military Academy”, “United States Naval Academy”, “United States Air Force Academy”, “United States Coast Guard Academy”, or “United States Merchant Marine Academy”.

5. The computerized method of claim 4, wherein the set of veteran-status related keywords comprises: “DD215”, “MOS”, or “Rank”.

6. The computerized method of claim 5, wherein the set of veteran-status related keywords comprises: “Time In Service”, “Duty Station”, “Enlisted”, or “Commissioned”.

7. The computerized method of claim 1 further comprising:
displaying the ordered set of search results.

8. The computerized method of claim 7 further comprising:
providing a dashboard interface of the online employee search tool that is displayed in a user's web browser.

9. The computerized method of claim 8, wherein a Natural language processing (NLP) algorithm is used to match the matching the set of profile content with a set of veteran-status related keywords.

10. The computerized method of claim 9, wherein a Regular Expression (REGEX) algorithm is used to match the matching the set of profile content with a set of veteran-status related keywords.

11. The computerized method of claim 1, wherein the specified number of matches comprises a single match between the set of profile content with the set of veteran-status related keywords.
